(19) United States
(12) Patent Application Publication
(10) Pub. No.: US 2025/0027544 A1
(43) Pub. Date: Jan. 23, 2025

(54) CALIPER BRAKE

(71) Applicant: HL MANDO CORPORATION, Gyeonggi-do (KR)

(72) Inventors: Yunkwang KIM, Gyeonggi-do (KR); Kisung JO, Gyeonggi-do (KR)

(21) Appl. No.: 18/599,236

(22) Filed: Mar. 8, 2024

(30) Foreign Application Priority Data
Jul. 17, 2023 (KR) 10-2023-0092201

(51) Int. Cl. F16D 55/227; F16D 55/00

(52) U.S. Cl. CPC F16D 55/227; F16D 2055/002

(57) ABSTRACT

A caliper brake includes a pressing member configured to press an inner brake pad toward a brake disc, a caliper housing in which at least a part of the pressing member is movably disposed, a caliper bridge connected to the caliper housing to cover an upper surface of the inner brake pad and upper and outward surfaces of the outer brake pad, a carrier fixedly installed to a vehicle body and including a guide hole formed to be recessed or pass through in forward and backward directions, and at least one guide member fixedly installed to the caliper housing and configured to slidable along the guide hole of the carrier to guide movement of the caliper housing and the caliper bridge with respect to the carrier.

### CROSS-REFERENCE TO RELATED APPLICATION

This application claims the priority to and the benefit of Korean Patent Application No. 10-2023-0092201, filed on Jul. 17, 2023 in the Korean Intellectual Property Office, the disclosure of which is incorporated herein by reference in its entirety.

### BACKGROUND

### 1. Field

Some embodiments of the present disclosure generally relate to a caliper brake, and more specifically, to a caliper brake which uses power of a motor to perform braking of a vehicle and may simplify a component structure and an exterior shape.

### 2. Description of the Related Art

Brake systems for performing braking are necessarily installed in vehicles, and various types of brake systems are developed for safety of passengers and cargo.

One of examples of the brake systems is a caliper brake. The caliper brake may be a brake system for generating a braking force through friction or clamping force between a disc and brake pads while the brake pads come into contact with and press against both sides of the disc which rotates with a wheel. Such a caliper brake may include a caliper covering the brake pads and configured to allow the brake pads to move toward or away from the disc, a cylinder and a piston. For example, as a hydraulic pressure for braking is applied to the inside of the cylinder, the piston moves forward and presses the brake pads toward the disc.

A caliper brake may comprise an actuator including an electric motor and a reducer so that the caliper brake receives an electrical signal indicating a driver's braking intention and operates an electric device such as the electric motor on the basis of the electrical signal to provide a braking force for parking of a vehicle or the like.

Meanwhile, a mono-block type caliper which has high rigidity and excellent appearance and is resistant against thermal deformation is being developed and applied to high-performance or advanced vehicles to improve the marketability or competitiveness of the products. The mono-block caliper may be formed by integrally manufacturing a caliper as a single component instead of assembling a plurality of components like the conventional caliper.

### SUMMARY

Therefore, it is an aspect of the present disclosure to provide a caliper brake which can simplify a component structure and an exterior shape.

It is another aspect of the present disclosure to provide a caliper brake which can reduce the number of components, thereby lowering manufacturing costs and improving productivity of the caliper brake.

It is still another aspect of the present disclosure to provide a caliper brake capable of stably performing the braking of a vehicle in various operating situations.

It is yet another aspect of the present disclosure to provide a caliper brake of which a size and volume of a product package of the caliper brake can be reduced to improve applicability to a vehicle and spatial utilization of the vehicle.

It is yet another aspect of the present disclosure to provide a caliper brake with the improved marketability and competitiveness of a vehicle.

It is yet another aspect of the present disclosure to provide a caliper brake improving an exterior appearance.

In accordance with one aspect of the present disclosure, a caliper brake includes a brake disc configured to rotate with a wheel, an inner brake pad and an outer brake pad disposed at both sides of the brake disc, a pressing member configured to press the inner brake pad toward the brake disc, a caliper housing provided so that the pressing member moves forward or backward, a caliper bridge connected to the caliper housing to surround an upper surface of the inner brake pad and upper and outward surfaces of the outer brake pad, a carrier fixedly installed on a vehicle body and including a guide hole formed to be recessed or pass through in forward and backward directions, and at least one guide member fixedly installed on the caliper housing and provided to slide along the guide hole to guide movement of the caliper housing and the caliper bridge with respect to the carrier.

The guide member may include a rod part inserted into the guide hole, a coupling part formed in an inner portion of the rod part to expand outward in a radial direction, and a bolt for coupling the caliper housing and the coupling part.

The caliper brake may further include a boot provided between the guide hole and the guide member.

The boot may be provided so that the guide member passes through an inner portion of the boot and include an outer end portion provided to be inserted into the guide hole, an inner end portion supported by the guide member, and a pleated part provided between the inner end portion and the outer end portion.

The guide hole may include an inner opening having an inner diameter greater than an inner diameter of the guide hole, and the outer end portion of the boot may be inserted into the inner opening.

The boot may further include a stopper protrusion formed on an outer circumferential surface between the outer end portion and the pleated part to expand outward in a circumferential direction to face or be in contact with an inward surface of the carrier.

The coupling part may include a seating groove formed in an outer circumferential surface of the coupling part to be recessed in a circumferential direction, and at least a part of the inner end portion of the boot may be inserted into the seating groove.

The guide member may further include a bush interposed between an inner circumferential surface of the guide hole and an outer circumferential surface of the rod part.

The rod part may include a bush accommodation groove formed in the outer circumferential surface thereof to be recessed in a circumferential direction so that at least a part of the bush is accommodated in the bush accommodation groove.

The outer end portion of the boot may include a support protrusion formed on an outer circumferential surface thereof to protrude in a circumferential direction, and the inner opening may include a protrusion accommodation groove formed in an inner circumferential surface thereof to be recessed in a circumferential direction so that at least a part of the support protrusion is accommodated in the protrusion accommodation groove.

The outer end portion of the boot may further include at least one sealing protrusion formed on an inner circumferential surface thereof to protrude in the circumferential direction to be in close contact with an outer circumferential surface of the rod part.

The coupling part may further include a fastening protrusion formed in the seating groove to protrude in a circumferential direction to be in close contact with an inner circumferential surface of the inner end portion of the boot.

The caliper bridge may include a display part of which at least a part is formed as a flat surface for a logo or emblem to be applied on a front surface of the caliper bridge.

The caliper bridge may include a pad support part formed to protrude from an inner surface of the caliper bridge to face or be in contact with the outward surface of the outer brake pad.

The caliper bridge and the caliper housing may be coupled to each other by at least one fastening member.

The guide member may be provided as a pair of guide members at both sides with respect to an axial direction of the pressing member.

The caliper brake may further include an actuator configured to move the pressing member forward or backward.

The actuator may include a motor configured to generate power, a power conversion unit configured to convert rotational power generated by the motor into linear motion and transmit the linear motion to the pressing member, and a deceleration unit configured to reduce the power generated by the motor and transmit the reduced power to the power conversion unit.

In accordance with another aspect of the present disclosure, a caliper brake includes a brake disc configured to rotate with a wheel, an inner brake pad and an outer brake pad disposed at both sides of a brake disc, a pressing member configured to press the inner brake pad toward the brake disc, a caliper housing provided so that the pressing member moves forward or backward, a caliper bridge connected to the caliper housing to cover a front surface of the caliper housing, a carrier fixedly installed on a vehicle body and formed to be recessed in or pass through the carrier in forward and backward directions, and at least one guide member fixedly installed on the caliper housing and provided to slide along the guide hole to guide movement of the caliper housing and the caliper bridge with respect to the carrier.

The guide hole may include an inner opening having an inner diameter greater than an inner diameter of the guide hole, wherein the caliper brake may further include a boot of which one end is inserted and supported between an inner circumferential surface of the inner opening and an outer circumferential surface of the guide member and the other end is supported by the outer circumferential surface of the guide member.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a caliper brake according to an embodiment of the present disclosure;

FIG. 2 is a plan view illustrating a caliper brake according to an embodiment of the present disclosure;

FIG. 3 is an exploded perspective view illustrating a caliper brake according to an embodiment of the present disclosure;

FIG. 4 is a perspective view illustrating a caliper bridge according to an embodiment of the present disclosure;

FIG. 5 is a cross-sectional view illustrating a guide member and a boot taken along line A-A′ of FIG. 2 according to an embodiment of the present disclosure; and

FIG. 6 is an exploded view illustrating portion B of FIG. 5.

### DETAILED DESCRIPTION

Hereinafter, embodiments of the present disclosure will be described in detail with reference to the accompanying drawings. The following embodiments are to provide the spirit of the present disclosure to those skilled in the art. The present disclosure is not limited to the embodiments disclosed herein and may be implemented in different forms. In the drawings, portions which are not related to the description may be omitted to clarify the present disclosure, and sizes of components may be exaggerated to facilitate understanding of the present disclosure.

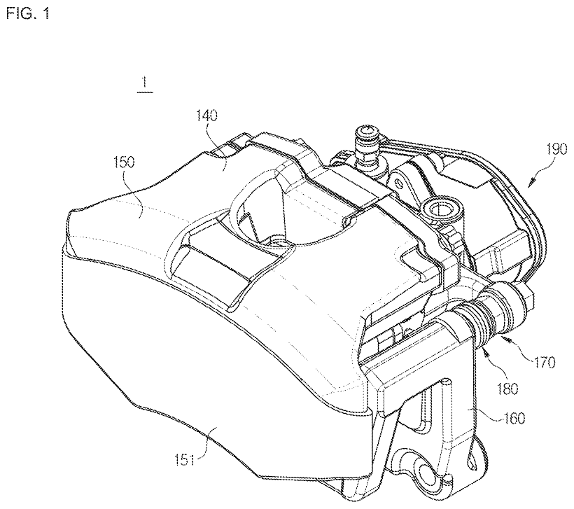

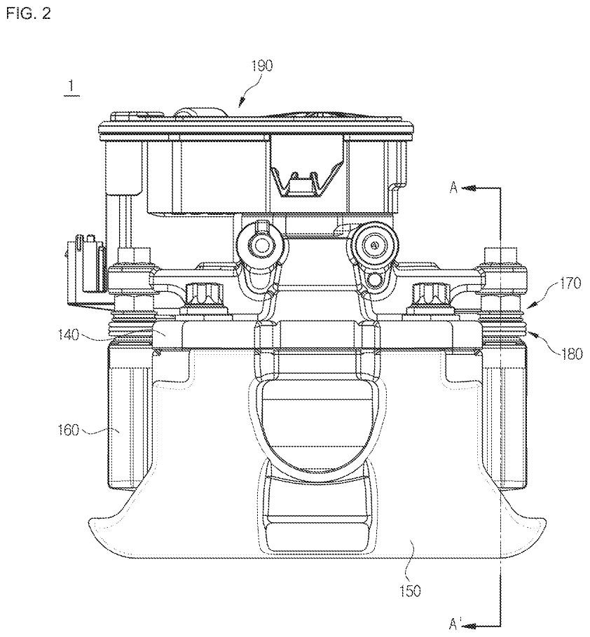

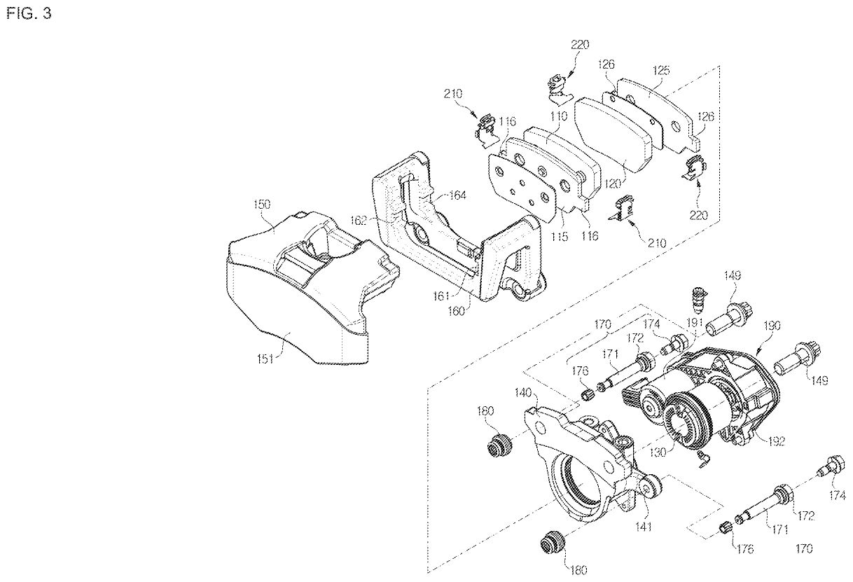

FIGS. 1 and 2 are a perspective view and a plan view illustrating a caliper brake 1 according to an embodiment of the present disclosure, and FIG. 3 is an exploded perspective view illustrating the caliper brake 1 according to an embodiment of the present disclosure.

Referring to FIGS. 1 to 3, the caliper brake 1 according to an embodiment of the present disclosure may include a brake disc or rotor 105, a pair of brake pads 110 and 120, a carrier 160, a caliper housing 140, a pressing member 130, a caliper bridge 150, guide members 170, boots 180, and an actuator 190. The brake disc 150 is configured to be rotatable with a wheel of a vehicle. The pair of brake pads 110 and 120 may be movably disposed at both sides of the brake disc 105. The carrier 160 is fixedly installed on a vehicle body and the inner brake pad 120 is installed to the carrier 160. The caliper housing 140 is installed to be slidable with respect to the carrier 160. The pressing member 130 may be installed on or in the caliper housing 140 to be movable forward or backward. The caliper bridge 150 may be connected to the caliper housing 140 and configured to be slidable with the caliper housing 140. The guide members 170 are fixedly installed in the caliper housing 140 to guide the sliding of the caliper housing 140 and the caliper bridge 150 with respect to the carrier 160. The boots 180 may be disposed or provided between the carrier 160 and the guide members 170. The actuator 190 may be configured to generate and provide a driving force for operating the pressing member 130.

The brake disc 105 may be provided to rotatable with the wheel of the vehicle, and the inner brake pad 120 and an outer brake pad 110 are disposed at or adjacent to both sides of the brake disc. The inner brake pad 120 and the outer brake pad 110 are fixedly installed on an inner pad plate 125 and an outer pad plate 115, respectively, and the brake pads 110 and 120 are attached to inner surfaces (e.g. surfaces facing the brake disc 105) of the pad plates 115 and 125. An outer surface of the inner pad plate 125 is disposed to be in contact with or operably associated with the pressing member 130, which will be described below in detail, and the outer pad plate 115 is installed at a side of an inner surface of the caliper bridge 150, which will be described below in detail, with the outer brake pad 110. Accordingly, when the vehicle brakes, the pressing member 130 moves forward to press the inner pad plate 125 and the inner brake pad 120 against the brake disc 105, and the caliper housing 140 and the caliper bridge 150 operably connected to the pressing member 130 slide with respect to the carrier 160 fixedly installed on the vehicle body in a direction opposite to a forward direction of the pressing member 130 as a reaction to the forward movement of the pressing member 130 so that the outer pad plate 115 and the outer brake pad 110 may be pressed against and in close contact with the brake disc 105.

Protruding parts 116 and 126 may be formed on both ends or sides of the inner pad plate 125 and the outer pad plate 115, and the protruding parts 116 and 226 may be movable or slidable in forward and backward directions within pad guide grooves 161, 162, 163, and 164 formed to be recessed in the carrier 160. Inner pad springs 220 and outer pad springs 210 may be interposed and installed between the protruding parts 116 and 126 and the pad guide grooves 161, 162, 163, and 164 to elastically support the brake pad 110 and 120 with respect to the carrier 160, and thus the brake pad 110 that has moved for braking can be returned to its original position when the braking is released.

The pressing member 130 may comprise, for example, but not limited to, a piston configured to be moved forward and backward inside a cylinder provided in the caliper housing 140. However, the pressing member 130 can be implemented with any structure (e.g. a nut part or a screw part of a nut-screw mechanism or a ball nut-screw mechanism) which is capable of pressing at least one of the brake pads 110 and 120 toward the brake disc 105. The pressing member 130 may be electromechanically operated by the actuator 190, which will be described below, to move forward to perform braking or parking of the vehicle and move backward to release the braking of the vehicle or a parking braking state of the vehicle. Alternatively, the pressing member 130 may be moved forward to perform braking or moved backward to release the braking of the vehicle by a hydraulic pressure of a brake oil.

The caliper housing 140 may include the cylinder or a substantially cylinder-shaped inner space in which the piston of the pressing member 130 is disposed to be moved forward and backward and coupling holes 141 which pass through both sides of the cylinder of the caliper housing 140 in a direction parallel to the forward and backward directions (or an axial direction) of the pressing member 130 and into which bolts 174 of the guide members 170 are inserted, and the caliper bridge 150 may be connected to and mounted on or to the caliper housing 140 by fastening members 149 to cover a front surface of the caliper housing 140. As the guide members 170, which will be described below, slide along guide holes 165 of the carrier 160 which will be described below, the caliper housing 140 and the caliper bridge 150 connected to the guide members 170 may move in the forward and backward directions with respect to the carrier 160.

Meanwhile, the front surface (or a front side) of the caliper brake 1 shown in FIG. 3 may be an outer surface (or an outer side) which may be visually checked by a driver or user from the outside of the vehicle, and the front surface (or a front side) of the caliper brake 1 is illustrated as a lower side (or lower portion) in FIG. 2. Conversely, a rear surface (or a rear side) of the caliper brake 1 illustrated in FIG. 3 may be an inner surface opposite to the front surface (or the front side) and the rear surface (or the rear side) of the caliper brake 1 is illustrated as an upper surface (or an upper side) in FIG. 2. In addition, the outer surface or side described in the present embodiment is in an outward direction based on the vehicle body and corresponds to a lower surface or side in FIG. 2, and the inner surface or side described in the present embodiment is in an inward direction based on the vehicle body and corresponds to an upper surface or side in FIG. 2. In addition, the forward and backward directions or an axial direction described in the present embodiment are directions in which the pressing member 130 moves forward and backward and/or are directions parallel to an axis of the pressing member 130 in a longitudinal direction.

The caliper bridge 150 may be connected to and mounted on or to the caliper housing 140 by the fastening members 149, and the caliper bridge 150 and the caliper housing 140 may be slidable with respect to the carrier 160. The caliper bridge 150 may be provided to surround or cover an upper surface of the inner brake pad 120 and upper and outward surfaces of the outer brake pad 110, and the inner surface of the caliper bridge 150 may be provided to face or be in contact with an outward surface of the outer pad plate 115 to support the outward surface of the outer pad plate 115. In addition, a display part 151 to which a logo or emblem of a product or vehicle can be applied may be provided on a front surface of the caliper bridge 150. The display part 151 may be provided such that at least a part of the display part 151 is formed as a flat surface on the front surface of the caliper bridge 150. The display part 151 may be visible from the outside of the vehicle.

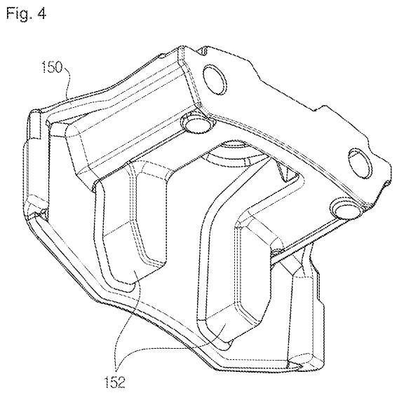

In the caliper bridge 150, pad support parts 152 configured to support the outer brake pad 110 or the outer pad plate 115 may be provided. FIG. 4 is a cross-sectional view illustrating a caliper bridge according to an embodiment of the present disclosure, and referring to FIG. 4, the pad support parts 152, which face or are in contact with the outer brake pad 110 or the outward surface of the outer pad plate 115, may be formed to protrude inward from the inner surface of the caliper bridge 150. The pad support parts 152 may be integrally provided with the caliper bridge 150, and a plurality of pad support parts 152 may be provided on the inner surface of the caliper bridge 150 to stably support and press the outer brake pad 110 or the outer pad plate 115 as illustrated in FIG. 4.

As the caliper bridge 150 is connected to and mounted on or to the caliper housing 140, when the caliper housing 140 is slid with respect to the carrier 160 by the guide members 170 which will be described below, the caliper bridge 150 may also slide together with the caliper housing 140. Accordingly, when the vehicle brakes, as the caliper housing 140 and the caliper bridge 150 slide in a direction opposite to a moving direction of the pressing member 130 as a reaction to a forward movement of the pressing member 130, the outer brake pad 110 provided at a side of the inner surface of the caliper bridge 150 may be pressed against and in close contact with the brake disc.

In addition, the caliper bridge 150 may be provided to cover the front surface of the caliper housing 140 to form an exterior of a product such as a brake assembly. To this end, the caliper bridge 150 is formed to cover the front surface of the caliper housing 140, and an upper surface of the caliper bridge 150 may extend inward to be connected and coupled to the caliper housing 140. As the caliper bridge 150 is provided to surround or cover various components such as the brake pads 110 and 120 and the pad plates 115 and 125 disposed inside the caliper bridge 150 and cover the entire front surface of the caliper housing 140, the interior of the product cannot be seen from the outside of the wheel or vehicle, components disposed inside of the product can be protected, and an exterior of the product viewed from the outside of the wheel or vehicle may be beautiful. In particular, nowadays, the wheel applied to a high-performance or advanced vehicle and the exterior of the caliper viewed from the outside are very important purchasing decision factors to consumers. Accordingly, since the caliper bridge 150 is provided to cover the front surface of the caliper housing 140 while surrounding various components disposed inside the caliper bridge 150, and the display part 151 on which a brand of the product or vehicle may be displayed is provided on the front surface, the marketability and competitiveness of the product and the vehicle can be improved.

The carrier 160 may be fixedly installed on a supportable fixture such as a vehicle body using, for example, but not limited to, a fastening member or fastener such as a bolt or a screw. A pair of guide holes 165 are formed to be recessed in or pass through both sides of the carrier 160 in the direction parallel to the forward and backward directions (e.g. a movable direction of the brake pads 110 and 120 or the axial direction of the pressing member 130) so that the guide members 170, which will be described below, are inserted into and pass through the pair of guide holes 165. In addition, in the carrier 160, pad guide grooves 161, 162, 163, and 164 are formed to be recessed may in the forward and backward directions so that protruding parts 116 of the outer pad plate 115 and protruding parts 126 of the inner pad plate 125 are inserted into and movably or slidably disposed in the pad guide grooves 161, 162, 163, and 164 and can be moved forward or backward along the pad guide grooves 161, 162, 163, and 164 of the carrier 160. The inner pad springs 220 and the outer pad springs 210 may be interposed between the protruding parts 116 and 126 of the brake pad 110 and 120 and the pad guide grooves 161, 162, 163, and 164 of the carrier 160 to elastically support the pad plates 115 and 125 with respect to the carrier 160.

The guide members or guides 170 are fixedly installed on both sides of the caliper housing 140 and are configured to guide the slide or movement of the caliper housing 140 and the caliper bridge 150 with respect to the carrier 160.

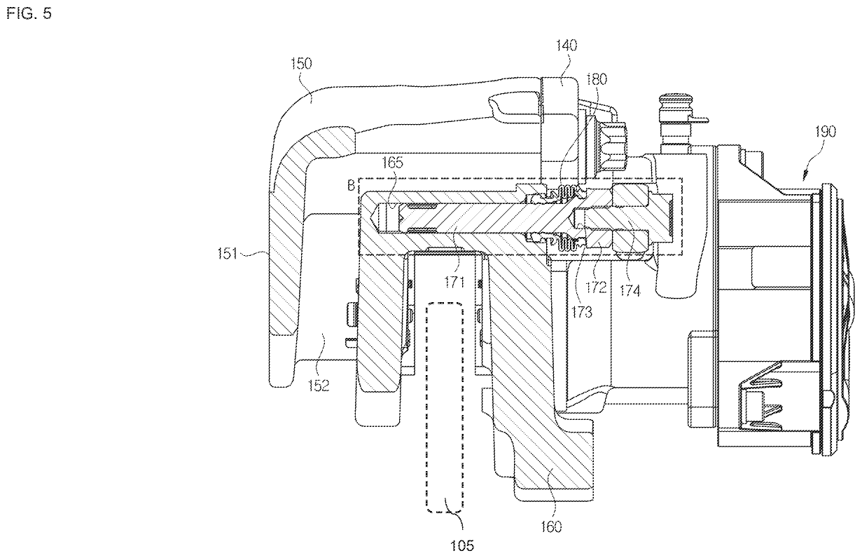

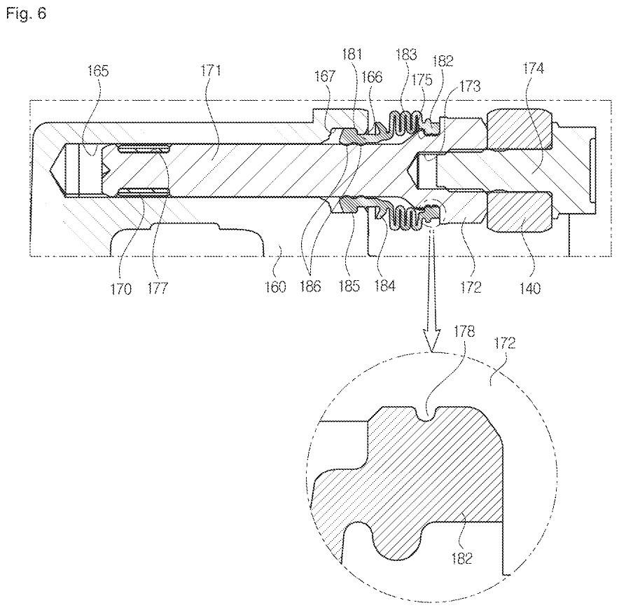

FIG. 5 is a cross-sectional view of a caliper brake taken along line A-A′ of FIG. 2, and FIG. 6 is an exploded view illustrating portion B of FIG. 5.

Referring to FIGS. 5 and 6, the guide members or guides 170 may include rod parts 171, coupling parts 172, and bolts 174. The rod parts 171 may be inserted into the guide holes 165 formed to be recessed in the carrier 160 in the forward and backward directions (e.g. a movable direction of the brake pads 110 and 120 or the axial direction of the pressing member 130). The coupling parts 172 are formed at or in the rod parts 171 to project or expand outward in a radial direction or outwardly protrude from the rod parts 171. The bolts 174 couples the caliper housing 140 and the coupling parts 172.

Meanwhile, in the caliper housing 140, a pair of guide members 170 may be symmetrically provided at or on both sides of the pressing member 130. When the brake disc 105 and brake pads 110 and 120 are in close contact with each other for braking the vehicle, loads may be applied to various components such as the caliper housing 140 and the caliper bridge 150 by the rotating wheel and the brake disc 1055, and thus various components including the caliper housing 140 and the caliper bridge 150 may be deformed. Accordingly, as the guide members 170 and the guide holes 165 of the carrier 160 are provided at both sides with respect to a central axis of the pressing member 130, the forward or backward movement of the caliper housing 140 and the caliper bridge 150 may be stably guided in spite of the loads applied to the caliper housing 140 and the caliper bridge 150 during the braking. In some exemplary embodiments illustrated in FIGS. 1 and 3, it is illustrated that the pair of guide members 170 are symmetrically provided on both sides of the pressing member 130, but the positions and the number of the guide members 170 are not limited thereto and may vary according to a weight of the vehicle or a capacity of the brake disc 105.

Each of the rod parts 171 may be provided in a substantially cylindrical shape and be arranged in the forward and backward directions (e.g. a movable direction of the brake pads 110 and 120 or the axial direction of the pressing member 130). The rod part 171 may slide while inserted in the guide hole 165. An outer diameter of the rod part 171 and an inner diameter of the guide hole 165 may correspond to each other so that the rod part 171 can stably and/or smoothly slide in the guide hole 165 and unnecessary gaps between the carrier 160, and the caliper housing 140 and the caliper bridge 150 can be also suppressed.

A bush accommodation groove 177 is formed to be recessed from an outer circumferential surface of the rod part 171 in a circumferential direction. At least a part of a bush 176 may be interposed between an inner circumferential surface of the guide hole 165 and the outer circumferential surface of the rod part 171. The bush 176 may be accommodated and seated in the bush accommodation groove 177. Although the outer circumferential surface of the rod part 171 and the inner circumferential surface of the guide hole 165 may occasionally or frequently come into contact with and rub against each other while the vehicle repeatedly brakes, the bush 176 may be disposed or seated in the bush accommodation groove 177 of the rod part 171 and interposed between the outer circumferential surface of the rod part 171 and the inner circumferential surface of the guide hole 165 to reduce wear of the rod part 171 or the guide hole 165 and allow stable sliding of the rod part 171 with respect to the guide hole 165.

Each of the coupling parts 172 may be formed on or in the rod part 171 to project or expand outward in the radial direction or outwardly protrude from the outer circumferential surface of the rod part 171 such that the coupling part 172 can have an outer diameter greater than the outer diameter of the rod part 171. The coupling part 172 may include a fastening hole 173 which is formed to be recessed in the forward and backward directions and have a screw thread on an inner circumferential surface of the fastening hole 173 so that the bolt 174 is fastened to the coupling hole 141 of the caliper housing 140 by passing through and being screwed or inserted into the coupling hole 141. A seating groove 175 may be formed on the coupling part 172 to be recessed in a circumferential direction of an outer circumferential surface of the coupling part 172 so that a part or one end of the boot 180, which will be described below, is inserted into and seated in, or fixed to, the coupling part 172, and in addition, a fastening protrusion 178 which is formed to protrude on the outer circumferential surface of the seating groove 175 of the coupling part 172 of the rod part 171 in a circumferential direction and is in contact with a part or one end of the boot 180, which will be described below, may be provided.

The bolt 174 may pass through the caliper housing 140 and may be inserted into and fastened to the fastening hole 173 of the coupling part 172 to fix the rod part 171 and the coupling part 172 to the caliper housing 140. For example, an outer circumferential surface of the bolt 174 has a screw thread engaged with a screw thread of the fastening hole 173. During the assembly of the rod part 171 and the coupling part 172, after the bolt 174 enters from or is inserted into the inside of the caliper housing 140 and passes through the caliper housing 140, the bolt 174 may be screwed to the fastening hole 173 of the coupling part 172 of the rod part 171.

Another part or end of the boot 180 may be provided between the guide hole 165 and the guide member 170 to prevent foreign matter or moisture from entering the guide hole 165. Specifically, the boot 180 may be formed of an elastically deformable material to have a substantially hollow cylindrical shape so that the guide member 170 passes through the inside or inner hole of the boot 180. The boot 180 may include an outer end portion 181 inserted into, or fixed to, the guide hole 165, an inner end portion 182 supported by, or fixed to, the guide member 170, and a pleated part 183 foldably provided between the inner end portion 182 and the outer end portion 181.

At least a part of the outer end portion 181 of the boot 180 may be inserted into the guide hole 165. To this end, the guide hole 165 may include an inner opening 166 of which an inner end has an inner diameter greater than the inner diameter of the guide hole 165, and the outer end portion 181 of the boot 180 may be inserted and interposed between an inner circumferential surface of the inner opening 166 of the guide hole 165 and the outer circumferential surface of the rod part 171. In addition, a support protrusion 185 is formed to protrude from an outer circumferential surface of the outer end portion 181 of the boot 180 in a circumferential direction, and a protrusion accommodation groove 167 is formed to be recessed on or in the inner opening 166 of the guide hole 165 in a circumferential direction and at least a part of the support protrusion 185 is inserted and accommodated in the protrusion accommodation groove 167, so that the outer end portion 181 of the boot 180 can be more securely supported in the guide hole 165. As the support protrusion 185 of the boot 180 is inserted and seated in the protrusion accommodation groove 167 of the guide hole 165, the outer end portion 181 of the boot 180 may be stably supported and maintained in the guide hole 165. In addition, one or more sealing protrusions 186 may be formed on the outer end portion 181 of the boot 180 to seal the inside and the outside of the guide hole 165 more tightly. The sealing protrusion 186 may be formed on an inner circumferential surface of the outer end portion 181 of the boot 180 to protrude in the circumferential direction to be in close contact with the outer circumferential surface of the rod part 171 of the guide member 170, thereby effectively preventing external foreign matter or moisture from entering the guide hole 165.

The inner end portion 182 of the boot 180 may be supported by, or fixedly coupled to, the coupling part 172 of the guide member 170. Specifically, the inner end portion 182 of the boot 180 may be supported by the outer circumferential surface of the coupling part 172 of the guide member 170, the seating groove 175 may be formed to be recessed from or in the outer circumferential surface of the coupling part 172 of the guide member 170 in a circumferential direction so that the inner end portion 182 of the boot 180 may be more firmly supported on or securely coupled to the guide member 170, and at least a part of the inner end portion 182 of the boot 180 may be inserted and mounted in the seating groove 175 of the coupling part 172. In addition, the fastening protrusion 178 may be provided at or in the seating groove 175 to be formed to protrude from the seating groove 175 in the circumferential direction to be in close contact with an inner circumferential surface of the inner end portion 182 of the boot 180 to increase a close contact force between the seating groove 175 of the guide member 170 and the inner end portion 182 of the boot 180 and stably support, or is securely coupled to, the inner end portion 182 of the boot 180 in the seating groove 175 and also improve the airtightness between the outside and an inner space of the boot 180.

The pleated part 183 is provided between the outer end portion 181 and the inner end portion 182 of the boot 180. As the pleated part 183 is provided to be flexible or foldable according to the axial movement of the guide member 170, the sealing between the outside and the guide hole 165 and between the outside and the inner space of the boot 180 may be maintained regardless of the movement of the guide member 170. A stopper protrusion 184 is provided or formed between the outer end portion 181 and the pleated part 183 of the boot 180. When the braking is performed abruptly, a speed or amount of displacement of the guide member 170 may increase rapidly. In this case, the boot 180 may be excessively inserted into the guide hole 165 or rapidly move toward the carrier 160 and therefore a part of the boot 180 may be stuck in the guide hole 165 and the boot 180 may be damaged when the guide member 170 returns to its original position in a state a part of the boot 180 is stuck in the guide hole 165. Accordingly, the stopper protrusion 184 may be formed to protrude outwardly or expand outward from an outer circumferential surface between the outer end portion 181 and the pleated part 183 of the boot 180 in the circumferential direction, and the stopper protrusion 184 is positioned to face an inward outside surface of the carrier 160 and is configured to be contactable with the inward side surface of the carrier 160 to prevent the sticking phenomenon of the boot 180 and also guide stable movement of the boot 180 in various braking situations. The stopper protrusion 184 can prevent a part of the boot 180 between the stopper protrusion 184 and the outer end portion 181 of the boot 180 being inserted into or stuck in the guide hole 165.

The actuator 190 may provide force or power to move the pressing member 130 forward or backward. The actuator 190 may include a motor 191, a power conversion unit or mechanism 192, and a deceleration unit or mechanism. The motor 191 may be configured to generate and provide a driving force to move the pressing member 130 forward or backward. The power conversion unit or mechanism 192 may be configured to convert rotational power or force provided by the motor 191 to linear movement to linearly move the pressing member 130 forward or backward. For instance, the power conversion unit or mechanism 192 may comprise a nut-screw mechanism or a ball nut-screw mechanism. Optionally, the deceleration unit or mechanism may be configured to reduce the power or force provided by the motor 191 and transmit the reduced power or force to the power conversion unit 192.

The motor 191 may operate by receiving power from a power supply such as a battery of the vehicle, and be configured to generate rotational power or force and transmit the rotational power or force to the deceleration unit. The deceleration unit may comprise one or more of gears, pulleys or a belt. For instance, the deceleration unit may have any one of various structures such as a planetary gear assembly or a worm structure to reduce the power or force of the motor 191 and transmit the reduced power to the power conversion unit 192, and the deceleration unit is not limited to a device having any one specific structure or operation method.

The power conversion unit 192 may include a spindle, a nut and a rotation prevention part. The spindle may be configured to rotatable by the power or force from the deceleration unit or the actuator 190. At least a part of the nut may be disposed inside the pressing member 130 and screwed to or operably coupled with the spindle. The rotation prevention part may be configured to prevent or block the nut from rotating so that the nut and the pressing member 130 can linearly move without rotating. For example, the rotation prevention part may be implemented as a guide rail or groove formed on the inner surface of the pressing member 130 and a groove or protrusion formed on the outer surface of the nut to be coupled to each other, although not limited there to. The spindle may be rotated in a first direction for applying brake by the power or force transmitted through the deceleration unit from the motor 191, and accordingly, the nut and the pressing member 130 may be moved forward toward the inner pad plate 125 to perform the braking of the vehicle. In addition, the spindle may be rotated in a second direction for releasing the brake, which is a direction opposite to the first direction, by the power or force transmitted through the deceleration unit from the motor 191 so that the nut and the pressing member 130 may be moved away or spaced apart from the inner pad plate 125 to release the braking of the vehicle.

A component structure and an exterior shape of a caliper brake according to some embodiments of the present disclosure can be simplified.

The number of components of a caliper brake according to certain embodiments of the present disclosure can be reduced, thereby lowering manufacturing costs and improving the productivity of the caliper brake.

A caliper brake according to some embodiments of the present disclosure can stably perform the braking of a vehicle in various operating situations.

A caliper brake according to certain embodiments of the present embodiment can reduce a size and volume of a product package of the caliper brake and improve the applicability of a vehicle and the spatial utilization of the vehicle.

The marketability and competitiveness of a vehicle comprising a caliper brake according to some embodiments of the present disclosure can be improved.

A caliper brake according to certain embodiments of the present disclosure can improve an exterior of a product of the caliper brake.

What is claimed is:

1. A caliper brake comprising:
a brake disc configured to be rotatable with a wheel;
an inner brake pad and an outer brake pad disposed at both sides of the brake disc, respectively;
a pressing member having a surface facing the inner brake pad to move the inner brake pad toward the brake disc;
a caliper housing in which at least a part of the pressing member is movably disposed;
a caliper bridge connected to the caliper housing and covering an upper surface of the inner brake pad and upper and outward surfaces of the outer brake pad;
a carrier including a guide hole formed in a direction in which the inner brake pad is movable; and
at least one guide member fixedly installed to the caliper housing and configured to be slidable along the guide hole of the carrier to guide movement of the caliper housing and the caliper bridge with respect to the carrier.

2. The caliper brake of claim 1, wherein the guide member fixedly installed to the caliper housing includes:
a rod part, wherein at least a part of the rod part is slidably disposed in the guide hole of the carrier; and
a coupling part coupled to the caliper housing and protruding from an outer surface of the rod part in a radial direction.

3. The caliper brake of claim 2, further comprising a boot coupled between the guide hole of the carrier and the guide member fixedly installed to the caliper housing.

4. The caliper brake of claim 3, wherein the guide member passes through an inner portion of the boot, one end portion of the boot is disposed in the guide hole of the carrier, an other end portion of the boot is coupled to the guide member, and a pleated part configured to be foldable is provided between the one end portion and the other end portion of the boot.

5. The caliper brake of claim 4, wherein:
the guide hole of the carrier includes an inner opening having an inner diameter greater than an inner diameter of the guide hole; and
the one end portion of the boot is disposed in the inner opening of the guide hole.

6. The caliper brake of claim 4, wherein the boot further includes a stopper protrusion protruding from an outer circumferential surface of the boot between the pleated part and the one end portion of the boot disposed in the guide hole of the carrier.

7. The caliper brake of claim 4, wherein at least a part of the outer end portion of the boot is disposed in a seating groove formed on an outer circumferential surface of the coupling part of the guide member coupled to the caliper housing.

8. The caliper brake of claim 2, further including a bush positioned between an inner circumferential surface of the guide hole of the carrier and an outer circumferential surface of the rod part of the guide member.

9. The caliper brake of claim 8, wherein the rod part of the guide member includes a bush accommodation groove formed on the outer circumferential surface of the rod part such that at least a part of the bush is disposed in the bush accommodation groove of the rod part.

10. The caliper brake of claim 5, wherein:
the one end portion of the boot has a support protrusion protruding from an outer circumferential surface of the one end portion of the boot; and
the inner opening of the guide hole of the carrier includes a protrusion accommodation groove recessed from an inner circumferential surface of the inner opening of the guide hole of the carrier so that at least a part of the support protrusion of the one end portion of the boot is inserted in the protrusion accommodation groove of the inner opening of the guide hole of the carrier.

11. The caliper brake of claim 10, wherein the one end portion of the boot further includes one or more sealing protrusions protruding from an inner circumferential surface of the one end portion of the boot to contact an outer circumferential surface of the rod part of the guide member.

12. The caliper brake of claim 7, wherein the coupling part of the guide member coupled to the caliper housing includes a fastening protrusion projecting from the seating groove of the coupling part of the guide member to contact an inner circumferential surface of the other end portion of the boot.

13. The caliper brake of claim 1, wherein the caliper bridge includes a display part having a flat surface for a logo or emblem on a surface of the caliper bridge facing an outside of the wheel.

14. The caliper brake of claim 13, wherein the caliper bridge includes a pad support part protruding from an inner surface of the caliper bridge toward the outer brake pad to face or contact the outward surface of the outer brake pad.

15. The caliper brake of claim 14, wherein the caliper bridge and the caliper housing are coupled to each other by at least one fastener.

16. The caliper brake of claim 3, wherein the at least one guide member comprises a pair of guide members at both side portions of the caliper housing and extending in a direction in which the pressing member is movable.

17. The caliper brake of claim 16, further comprising an actuator configured to move the pressing member.

18. The caliper brake of claim 17, wherein the actuator includes:
a motor configured to generate rotational force;
a deceleration unit configured to reduce the rotational force generated by the motor and transmit the reduced rotational force; and
a power conversion unit configured to convert the transmitted rotational force into a linear movement to linearly move the pressing member.

19. A caliper brake comprising:
a brake disc configured to be rotatable with a wheel;
an inner brake pad and an outer brake pad disposed at both sides of a brake disc, respectively;
a pressing member having a surface facing the inner brake pad to move the inner brake pad toward the brake disc;
a caliper housing in which at least a part of the pressing member is movably disposed;
a caliper bridge connected to the caliper housing and covering a front surface of the caliper housing;
a carrier having a guide hole formed in a direction in which the inner brake pad is movable; and
at least one guide member fixedly installed to the caliper housing and configured to be slidable along the guide hole of the carrier to guide movement of the caliper housing and the caliper bridge with respect to the carrier.

20. The caliper brake of claim 19, wherein:
the guide hole of the carrier includes an inner opening having an inner diameter greater than an inner diameter of the guide hole,
the caliper brake further comprises a boot, wherein one end of the boot is inserted between an inner circumferential surface of the inner opening of the guide hole of the carrier and an outer circumferential surface of the guide member and another end of the boot is coupled to the outer circumferential surface of the guide member.
